(19) United States
(12) Patent Application Publication
(10) Pub. No.: US 2022/0085672 A1
(43) Pub. Date: Mar. 17, 2022

(54) ROTOR OF AN ELECTRICAL MACHINE WITH IMPROVED STAGGERING OF THE ROTOR SEGMENTS

(71) Applicant: Valeo Siemens eAutomotive Germany GmbH, Erlangen (DE)

(72) Inventors: Sebastian Beetz, Bad Neustadt a.d.Saale (DE); Boris Dotz, Bad Neustadt a.d.Saale (DE); Christian Finger-Albert, Bad Neustadt a.d.Saale (DE); David Förster, Bad Neustadt a.d.Saale (DE)

(73) Assignee: Valeo Siemens eAutomotive Germany GmbH, Erlangen (DE)

(21) Appl. No.: 17/471,917

(22) Filed: Sep. 10, 2021

(30) Foreign Application Priority Data
Sep. 11, 2020 (DE) 10 2020 211 452.8

(51) Int. Cl. H02K 1/27; H02K 7/04; B60K 1/00

(52) U.S. Cl. CPC H02K 1/276; B60K 1/00; H02K 7/04

(57) ABSTRACT

A rotor (3a . . . 3c) for an electrical machine (1) is described which comprises several rotor segments (10a . . . 10c, 10a′, 10a″, 10 . . . 10′″) which are arranged successively along the rotational axis (x) of the rotor (3a . . . 3c) and each comprise a rotor plate (11) or several rotor plates (11). Magnetic poles (A . . . D) of two adjacent rotor segments (10a . . . 10c, 10a′, 10a″, 10 . . . 10′″) are twisted relative to one another around the rotational axis (x) of the rotor (3a . . . 3c) by a staggering angle (α), wherein the staggering angle (α) is smaller than a polar angle (β) lying between two magnetic poles (A . . . D) of a rotor segment (10a . . . 10c, 10a′, 10a″, 10 . . . 10′″). The rotor (3a . . . 3c) comprises at least two first cutouts (12) which are arranged on a first hole circle (L1) around the rotational axis (x) of the rotor (3a . . . 3c) and are each twisted relative to one another by an angle (γ) which corresponds to the polar angle (β) minus or plus the staggering angle (α). Furthermore, an electrical machine (1) with such a rotor (3a . . . 3c), and a vehicle (18) with such an electrical machine (1), are described.

### TECHNICAL FIELD

The invention concerns a rotor for an electrical machine which comprises several rotor segments which are arranged successively along the rotational axis of the rotor and each comprise a rotor plate or several rotor plates, wherein magnetic poles of two adjacent rotor segments are twisted relative to one another around the rotational axis of the rotor by a staggering angle. The staggering angle is here smaller than a polar angle lying between two magnetic poles of a rotor segment. The polar angle results from division of a full circle (=360°) by the number of magnetic poles of a rotor segment. Furthermore, an electrical machine with such a rotor, and a vehicle with such an electrical machine, are described.

### PRIOR ART

In electrical machines, it is known to twist rotor segments of a rotor relative to one another in order, in operation of the electrical machine, to achieve a torque curve which has fewer torque fluctuations compared with a torque curve of an electrical machine with axially aligned rotor segments. In the prior art, some methods have been proposed for producing such a rotor, but there is no simple possibility of orienting the rotor segments which allows a plurality of angular positions of the magnetic poles of a rotor and in particular can be achieved with identically constructed rotor plates of the rotor.

### DISCLOSURE OF THE INVENTION

It is therefore an object of the invention to provide an improved rotor for an electrical machine, an improved electrical machine, and an improved vehicle with such an electrical machine. In particular, the twisting of rotor segments of a rotor (i.e. skewing) is to be facilitated.

The object of the invention is achieved with a rotor of the type cited initially having at least two cutouts which are arranged on a first hole circle around the rotational axis of the rotor, and which are each twisted relative to one another by an angle which corresponds to the polar angle minus or plus the staggering angle.

The object of the invention is also achieved with an electrical machine which comprises a stator and a rotor of the above-mentioned type, which is mounted so as to be rotatable relative to the stator about the rotational axis of the rotor.

Finally, the object is also achieved by a vehicle with at least two axles, of which at least one is driven, wherein said drive is provided at least partially or for part of the time by the above-mentioned electrical machine.

By means of the proposed measures, the disadvantages cited initially may be overcome. In particular, the proposed arrangement allows simple orientation of the rotor segments, wherein a plurality of angular positions of the magnetic poles of a rotor can be achieved, and which in particular can be constructed with identically structured rotor plates of the rotor. In concrete terms, only various first cutouts of the rotor segments need be brought into congruence in order to achieve a predefined skew of the rotor segments. The first cutouts may be formed for example by cylindrical holes, but in principle the first cutouts may assume any arbitrary form. First cutouts which are brought into congruence on twisting of the rotor segments by the staggering angle or by an integral multiple of the staggering angle should however all have a unitary form.

A specific angular position may be ensured for example if a pin is passed through the first cutouts of several rotor segments. This pin may facilitate alignment during production of the rotor and be removed again after completion thereof, or the pin may also remain in the rotor. It is naturally also possible to fit several pins. Said pins may simultaneously also be configured as tension rods and axially secure the rotor segments. Naturally, also separate tension rods may be used for this.

In principle, it is also possible that the proposed measures apply to a group of first cutouts. The rotor then comprises at least two groups of first cutouts which are arranged on a first hole circle around the rotational axis of the rotor, wherein the groups are each twisted relative to one another by an angle which corresponds to the polar angle minus or plus the staggering angle. Said advantages apply accordingly.

Further advantageous embodiments and refinements of the invention arise from the subclaims and from the description considered in conjunction with the figures.

It is favourable if the rotor comprises at least n/2 first cutouts (or n/2 groups of first cutouts) arranged on the first hole circle, of which at least n/2−1 first cutouts (or groups) are each twisted relative to one another by an angle which corresponds to the polar angle minus or plus the staggering angle, wherein n indicates the number of magnetic poles of a rotor segment. In this way, all rotor segments may be twisted relative to one another by a pre-definable angle.

It is furthermore favourable if in each case two first cutouts (or groups of first cutouts) lying opposite one another in pairs are arranged on a straight line through the centre of the first hole circle. This effectively avoids an imbalance. In principle, an imbalance of the rotor may also be avoided in another way.

It is particularly advantageous if the rotor has a first cutout which is arranged on the first hole circle and is twisted relative to a polar axis of a magnetic pole by half the staggering angle. In this way, by rotating or turning a rotor segment by 180° about an axis leading through the first cutout, a skewing of magnetic poles of two adjacent rotor segments by the staggering angle can be achieved. The proposed measures increase the possibilities for the skewing of rotor segments.

It is particularly advantageous also if the rotor has a group of first cutouts arranged on the first hole circle, wherein an axis of symmetry of the group passing through the rotational axis of the rotor is twisted relative to a polar axis of a magnetic pole by half the staggering angle. By rotating or turning a rotor segment by 180° around the axis of symmetry, again a skewing of magnetic poles of two adjacent rotor segments by the staggering angle is possible. The proposed measures also increase the possibilities for the skewing of rotor segments.

A combination of claims 1, 2 and 5 is also particularly advantageous. This gives the following arrangement:

A rotor for an electrical machine, having:
several rotor segments which are arranged successively along the rotational axis of the rotor and each comprise a rotor plate or several rotor plates, wherein magnetic poles of two adjacent rotor segments are twisted relative to one another around the rotational axis of the rotor by a staggering angle, and wherein the staggering angle is smaller than a polar angle lying between two magnetic poles of a rotor segment, and
n/2 groups of first cutouts which are arranged on the first hole circle and which each have an axis of symmetry passing through the rotational axis of the rotor, and of which at least n/2−1 groups are each twisted relative to one another by an angle,
wherein n indicates the number of magnetic poles of a rotor segment,
wherein the axes of symmetry of different groups are each twisted relative to one another by an angle which corresponds to the polar angle minus or plus the staggering angle, and
wherein an axis of symmetry of a first group is twisted relative to a polar axis of a magnetic pole by half the staggering angle.

It is furthermore favourable if the rotor comprises several second cutouts which are arranged on a second hole circle and which can be fitted with a balancing weight, or of which at least some are fitted with a balancing weight. By selectively fitting the second cutouts with balancing weights, the rotor can be balanced.

It is advantageous if several second cutouts are twisted relative to one another in the same fashion as the first cutouts with respect to their angular position. In this way, a balancing weight may also extend over several rotor segments. In particular, it is advantageous if at least two second cutouts are each twisted relative to one another by an angle which corresponds to the polar angle minus or plus the staggering angle, and the balancing weight extends over at least two rotor segments.

Finally, it is also favourable if the magnetic poles of the successively arranged rotor segments

a) starting from one end of the rotor, are each twisted relative to one another in a first direction by a staggering angle progressively, or
b) starting from one end of the rotor up to the middle of the rotor, are each twisted relative to one another in a first direction by a staggering angle progressively, and starting from the middle of the rotor up to the other end of the rotor, are each twisted relative to one another in a second opposite direction by a staggering angle progressively.

Case a) allows a particularly simple construction of the rotor, while the symmetrical structure in case b) offers the advantage over a non-symmetrical structure that, in operation of the electrical machine, no axial force is generated by the skewing of the rotor segments.

The above embodiments and refinements of the invention may be combined in arbitrary fashion.

### BRIEF DESCRIPTION OF THE FIGURES

Exemplary embodiments of the invention are shown as examples in the appended schematic figures. The drawings show:

FIG. 1 a schematic half-sectional view of an exemplary electrical machine;

FIG. 2 the rotor of the electrical machine from FIG. 1 in an oblique view;

FIG. 3 the foremost rotor segment of the rotor from FIG. 2 in front view;

FIG. 4 a derivative of the rotor segment shown in FIG. 3, in which a group of first cutouts is twisted clockwise relative to a magnetic axis by half the staggering angle;

FIG. 5 as FIG. 4, but with a counterclockwise twist of the group of first cutouts;

FIG. 6 an exemplary rotor with rotor segments in the manner of FIG. 4;

FIG. 7 an exemplary rotor with rotor segments in the manner of FIG. 5;

FIG. 8 a rotor segment with two cutouts for balancing weights; and

FIG. 9 an electrical machine with a rotor of the proposed type, which is installed in a vehicle.

### DETAILED DESCRIPTION OF THE INVENTION

Initially, it is stated that identical parts in the different embodiments carry the same reference signs or same component designations, but in some cases with different indices. The disclosures of a component contained in the description may accordingly be transferred to another component with the same reference sign or same component designation. Also, the positional data selected in the description, such as e.g. “top”, “bottom”, “rear”, “front”, “side” etc. relate to the figure directly described and depicted, and on a position change, should be transferred accordingly to the new position.

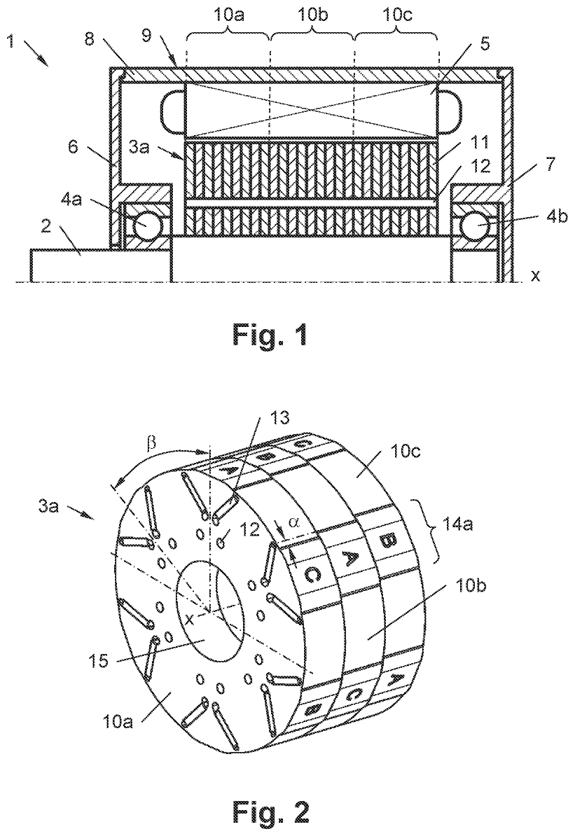

FIG. 1 shows a half section through a schematically depicted electrical machine 1. The electrical machine 1 comprises a shaft 2 with a rotor 3a sitting thereon, wherein the shaft 2 is mounted by means of (roller) bearings 4a, 4b so as to be rotatable about a rotational axis x relative to a stator 5. In this example, the stator 5 has several stator plates (not shown in detail) and stator windings arranged therein. In concrete terms, the first bearing 4a sits in a front end shield 6, and the second bearing 4b sits in a rear end shield 7. Furthermore, the electrical machine 1 comprises a (middle) housing part 8 which connects the front end shield 6 and rear end shield 7 and receives the stator 5. The front end shield 6, the rear end shield 7 and the housing part 8 in this example form the housing 9 of the electrical machine 1.

The rotor 3a comprises several rotor segments 10a . . . 10c which are arranged successively along the rotational axis x of the rotor 3a and which each comprise a rotor plate 11 or—as is the case in FIG. 1—several rotor plates 11. The rotor 3a in cross-section also has a through bore which is formed by first cutouts 12 in the individual rotor plates 11.

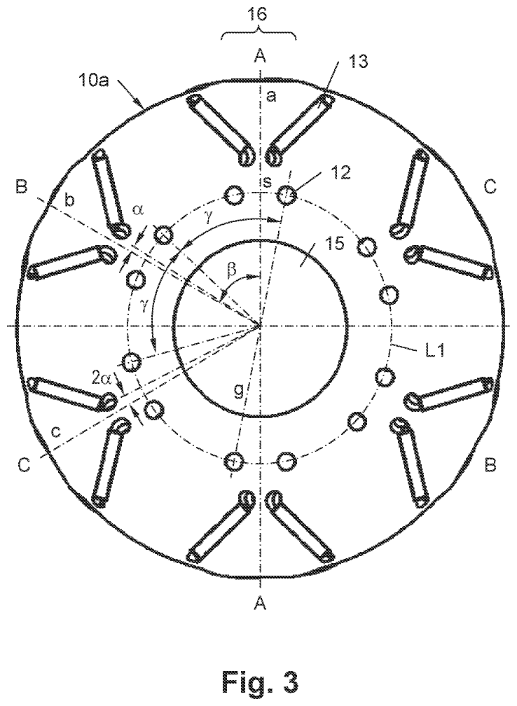

FIG. 2 shows the rotor 3a of the electrical machine 1 in an oblique view, while FIG. 3 shows the first rotor segment 10a of the rotor 3a in front view.

Magnetic poles A . . . C of two adjacent rotor segments 10a . . . 10c are twisted relative to one another about the rotational axis x of the rotor 3a by a staggering angle α (see in particular FIG. 3). The staggering angle α is here smaller than a polar angle β lying between two magnetic poles A . . . C of a rotor segment 10a . . . 10c, which results in concrete terms from division of a full circle)(=360° by the number of magnetic poles A . . . C of the rotor segment 10a . . . 10c. In the present example, the rotor 3a has six magnetic poles A . . . C. The polar angle β is thus 60°. The magnetic poles A . . . C lie on respective polar axes a . . . c. Furthermore, magnets 13 which generate a magnetic field are arranged in the region of the magnetic poles A . . . C.

The rotor segment 10a has several first cutouts 12 which are arranged on a first hole circle L1 around the rotational axis x of the rotor 3a, and are each twisted relative to one another by an angle γ which corresponds to the polar angle β minus or plus the staggering angle α. In the example shown, the angle γ corresponds to the polar angle β minus the staggering angle α.

In this example, it is furthermore assumed that the rotor segments 10a . . . 10c or their rotor plates 11 are structured identically. If now the first cutouts 12 assigned to the magnetic pole B are brought into congruence with the first cutouts 12 assigned to the magnetic pole A, this gives the skewing (clearly evident in FIG. 2) between the first rotor segment 10a and the second rotor segment 10b. If furthermore the first cutouts 12 assigned to the magnetic pole C are brought into congruence with the first cutouts 12 assigned to the magnetic pole B, this gives the skewing (also clearly evident in FIG. 2) between the second rotor segment 10b and the third rotor segment 10c. The magnetic poles A . . . C together give a polar arrangement 14a extending in the longitudinal direction of the rotor 3a. In addition, FIGS. 2 and 3 clearly show the shaft bore 15 of the rotor 3a.

It is pointed out here that the magnetic poles A . . . C of a polar arrangement 14a extending in the longitudinal direction are oriented magnetically identically. The vec-tors of the magnetic poles A . . . C of the respective polar arrangement 14a extending in the longitudinal direction therefore all point out of or into the rotor 3a. The polar arrangement 14a lying opposite with respect to the rotational axis x on the polar axis a . . . c is magnetised in reverse. In operation of the electrical machine 1, the skewing of the rotor segments 10a . . . 10c gives a torque curve which has fewer torque fluctuations compared with the torque curve of an electrical machine with axially aligned rotor segments 10a . . . 10c.

In the above example, it was assumed that the rotor segments 10a . . . 10c or their rotor plates 11 are identically structured. This is indeed advantageous but not abso-lutely essential. For the given function, it is sufficient if the rotor segments 10a . . . 10c or their rotor plates 11 have first cutouts 12 which are arranged in the indicated fashion. The first cutouts 12 also need not be arranged in the spatial vicinity of the magnetic poles A . . . C, but may be arranged at arbitrary angular positions relative thereto.

In this example, also each two first cutouts 12 lying opposite one another in pairs are arranged on a straight line g through the centre of the first hole circle L1. This avoids imbalance. It is however also conceivable that an imbalance is achieved by other measures, and first cutouts 12 lying opposite one another in pairs do not lie on a straight line g.

In principle, it is sufficient if two first cutouts 12 are each twisted relative to one another by an angle γ which corresponds to the polar angle β minus or plus the staggering angle α. Thus two rotor segments 10a . . . 10c may be twisted relative to one another by the staggering angle α.

It is however advantageous if the rotor segment 10a, as in the example shown, comprises (at least) n/2 first cutouts 12 arranged on the first hole circle L1, of which at least n/2−1 first cutouts 12 are twisted relative to one another by the angle γ which corresponds to the polar angle β minus or plus the staggering angle α. Thus all rotor segments 10a . . . 10c may be twisted relative to one another by the staggering angle α.

It is pointed out here that the rotor segment 10a has groups 16 of first cutouts 12. In concrete terms, in each case two first cutouts 12 may be combined into a group 16. An axis of symmetry s of the group 16 assigned to the magnetic pole A in this example coincides with the polar axis a of the magnetic pole A. The measures out-lined above for the individual first cutouts 12 and the resulting advantages also apply accordingly to the groups 16.

The rotor segment 10a has at least n/2 groups 16 of first cutouts 12, which are each twisted relative to one another by an angle γ which corresponds to the polar angle β minus the staggering angle α, wherein again n indicates the number of magnetic poles A . . . C of a rotor segment 10a. Furthermore, in each case two groups 16 lie opposite one another in pairs on a straight line (here the axis of symmetry s) through the centre of the first hole circle L1.

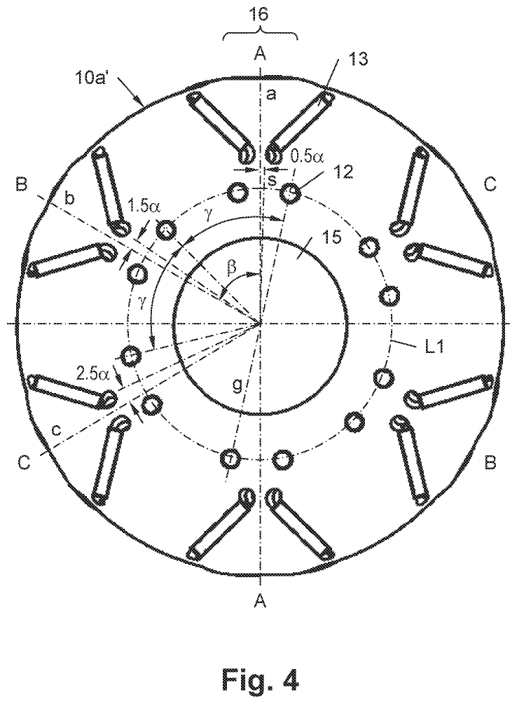

FIG. 4 now shows an embodiment of a rotor segment 10a′ which is very similar to the rotor segment 10a from FIG. 3. Like the rotor segment 10a from FIG. 3, the rotor segment 10a′ from FIG. 4 also has groups 16 of first cutouts 12 arranged on the first hole circle L1. In concrete terms, again in each case two first cutouts 12 are combined into a group 16. In contrast to the rotor segment 10a from FIG. 3, the rotor segment 10a′ from FIG. 4 however comprises a group 16 in which an axis of symmetry s of the group 16 passing through the rotational axis x of the rotor 3a . . . 3c is twisted, in this case clockwise, relative to the polar axis a of the magnetic pole A by half the staggering angle 0.5α. This measure allows a skewing of two rotor segments 10a . . . 10c by the staggering angle α or a multiple thereof if the twisting described in FIG. 3 is performed, or by the staggering angle α in the opposite direction if a rotor segment 10a is rotated or turned by 180° about the axis of symmetry s of the group 16. On additional, subsequent twisting by the angle γ, multiples of the staggering angle α can also be achieved. The rotor segment 10a′ shown in FIG. 4 is an example of a rotor segment in which n/2 first cutouts 12 are each twisted relative to one another by the angle γ. In this case, the rotor segment 10a′ has six magnetic poles A . . . C, and there are three cutouts 12 (or here groups 16), which are each twisted relative to one another by the angle γ (the opposite groups 16 are disregarded in this arrangement).

The embodiment of FIG. 4 allows a twist by −α, −2α, +α, +2α and +3α starting from the polar axis a, wherein positive values indicate a clockwise twist and negative values a counterclockwise twist. In this embodiment, negative values are achieved without turning, while positive values include a turn of the rotor segment 10a′. The table below shows this again in a clear form, wherein turned rotor segments 10a′ are indicated by “−” in front of the corresponding magnetic pole A . . . C,

| C | B | A | −A | −B | −C |
|---|---|---|---|---|---|
| −2α | −α | 0° | +α | +2α | +3α |

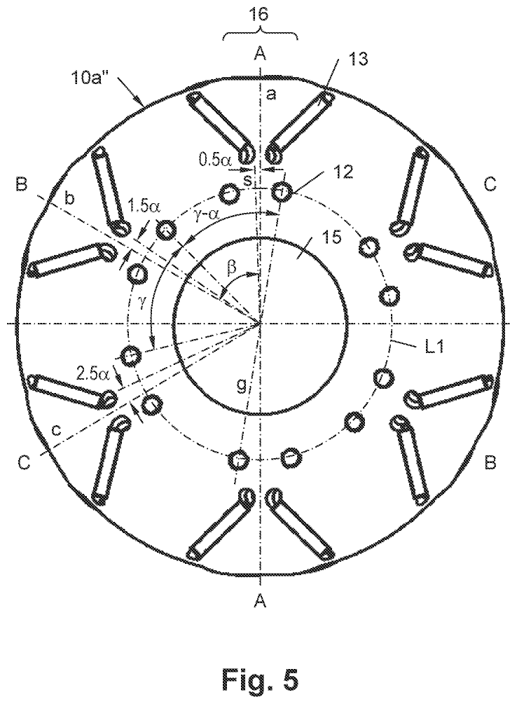

FIG. 5 shows an embodiment of a rotor segment 10a″ which is very similar to the rotor segment 10a′ from FIG. 4. In contrast, the group 16 assigned to the magnetic pole A is however twisted in the opposite direction, namely counterclockwise by the angle 0.5α. This gives the following possible sequence of the magnetic poles A . . . C.

| C | B | −A | A | −B | −C |
|---|---|---|---|---|---|
| −3α | −2α | −α | 0° | +α | +2α |

The rotor segment 10a″ shown in FIG. 5 is an example of a rotor segment in which (at least) n/2−1 first cutouts 12 are each twisted relative to one another by the angle γ. In this case, the rotor segment 10a′ has six magnetic poles A . . . C, and there are two cutouts 12 (or groups 16), which are each twisted relative to one another by the angle γ (the opposite groups 16 are again disregarded in this arrangement).

In principle however, other arrangements, not shown in detail, are also possible. In particular, the tables may be extended in the case of a greater number of magnetic poles A . . . C, or shortened for a smaller number. The tables are shown below for magnetic poles A . . . D in the manner of FIG. 4 and below this in the manner of FIG. 5.

| D | C | B | A | −A | −B | −C | −D |
|---|---|---|---|---|---|---|---|
| −3α | −2α | −α | 0° | +α | +2α | +3α | +4α |

| D | C | B | −A | A | −B | −C | −D |
|---|---|---|---|---|---|---|---|
| −4α | −3α | −2 | −α | 0° | +α | +2α | +3α |

In the examples shown, each group 16 comprises two first cutouts 12. This is not however a necessary condition, but a group 16 may in principle contain any arbitrary number of several first cutouts 12. The first cutouts 12 of a group 16 should however preferably remain congruent on turning of the rotor segment 10a through 180° about the axis of symmetry s.

In a derivative of the examples shown in FIGS. 4 and 5, it is conceivable that only one first cutout 12 arranged on the first hole circle L1 is twisted relative to a polar axis a of a magnetic pole A by half the staggering angle 0.5α.

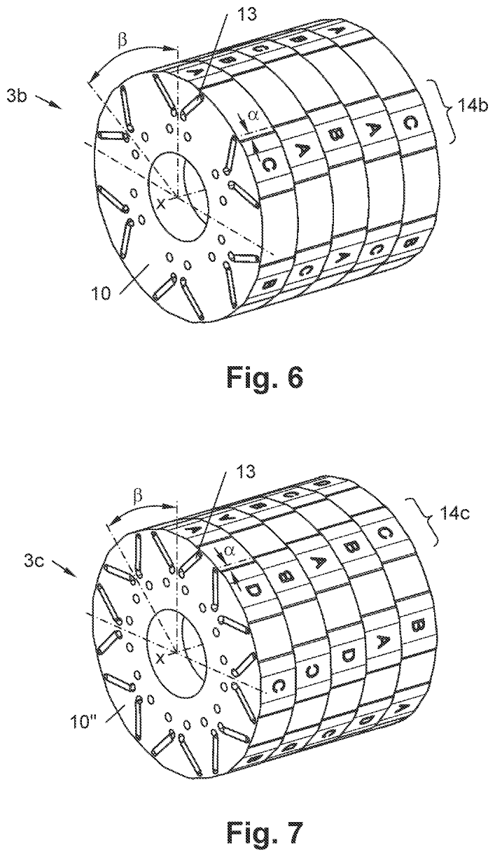

FIG. 6 now shows a further exemplary embodiment of a rotor 3b which is very similar to the rotor shown in FIG. 3. However, the rotor 3b has five rotor segments 10 which are symmetrically skewed. In other words, this means that the magnetic poles A . . . C of the successively arranged rotor segments 10a . . . 10c, in the case of FIG. 3, starting from one end of the rotor 3a, are each twisted relative to one another in a first direction by a staggering angle α progressively, and in the case of FIG. 6, starting from one end of the rotor 3b up to the middle of the rotor 3b, are each twisted relative to one another in a first direction by a staggering angle α progressively, and starting from the middle of the rotor 3b up to the other end of the rotor 3b, are twisted relative to one another in a second opposite direction by a staggering angle α progressively. A symmetrical structure according to the pattern of FIG. 6 offers the advantage over a non-symmetrical rotor 3a that, in operation of the electrical machine 1, no axial force is generated by the skewing of the rotor segments 10.

FIG. 7 shows an example of a rotor 3c which is constructed using rotor segments 10″ according to the pattern of FIG. 5, in which a group 16 a first cutouts 12 is twisted counterclockwise relative to a polar axis a of a magnetic pole A by half the staggering angle 0.5α. In contrast, the rotor 3a however has eight magnetic poles A . . . D. As evident from FIG. 7, starting from one end of the rotor 3c, the five rotor segments 10″ of the rotor 3c are each twisted in a first direction by the staggering angle α. The arrangement of the magnetic poles A . . . D corresponds to an extract of the table relating to FIG. 5, wherein the arrangement of the magnetic poles A . . . D is reversed in the view of FIG. 7. Viewed from the back, it would correspond directly to the table below.

| D | C | B | −A | A |
|---|---|---|---|---|
| −4α | −3α | −2α | −α | 0° |

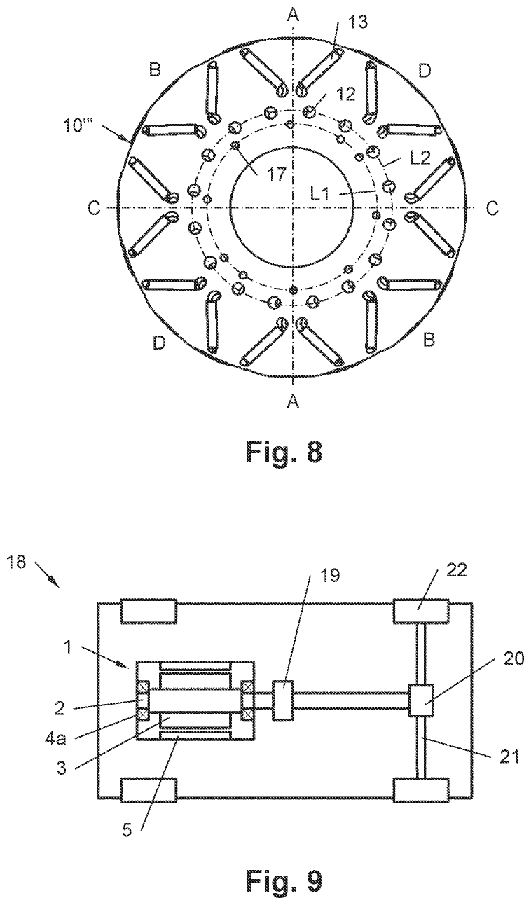

FIG. 8 shows a rotor segment 10′″ which is a derivative of the rotor segment 10″ used for the rotor 3c shown in FIG. 7. In this case, the rotor segment 10′″ comprises several second cutouts 17 which are arranged on a second hole circle L2 and can be fitted with a balancing weight, or of which at least some are fitted with a balancing weight. By selectively fitting the second cutouts 17 with a balancing weight, the rotor 3c can be balanced.

It is favourable if the same measures are taken with respect to an angular offset of several second cutouts 17 as for the first cutouts 12.

For example, at least two first cutouts 17 may each be twisted relative to one another by an angle γ which corresponds to the polar angle β minus or plus the staggering angle α. In this way, a balancing weight may also extend over two rotor segments 10a . . . 10c.

It is also pointed out here that it is possible for the first cutouts 12 to be fitted with corresponding pins for alignment of the rotor segments 10a . . . 10c only during production of the rotor 3a . . . 3c, but it is also possible that these pins remain perma-nently in the first cutouts 12 and prevent an undesired skewing of the rotor segments 10a . . . 10c in operation of the electrical machine 1. Said pins may in particular also be configured as tension rods and axially secure the rotor segments 3a . . . 3c. Evidently however, separate tension rods may also be provided, or other measures may be taken for axially securing the rotor 3a . . . 3c.

FIG. 9 finally shows an electrical machine 1 installed in a vehicle 18. The vehicle 18 has at least two axles, at least one of which is driven. In concrete terms, the electric motor 1 is connected to an optional gear mechanism 19 and a differential gear 20. The half shafts 21 of the rear axle adjoin the differential gear 20. Finally, the driven wheels 22 are mounted on the half shafts 21. The drive of the vehicle 18 is provided at least partially or for part of the time by the electrical machine 1. This means that the electrical machine 1 may serve for solely driving the vehicle 18, or for example may be provided in conjunction with an internal combustion engine (hybrid drive).

Finally, it is established that the scope of protection is determined by the patent claims. The description and the drawings should however serve as reference for interpretation of the claims. The features contained in the figures may be inter-changed and combined with one another arbitrarily. In particular, it is also established that the devices depicted may in reality comprise more or also fewer constituents than illustrated. In some cases, the illustrated devices or their constituents may also not be depicted to scale, and/or may be enlarged and/or reduced.

1. A rotor for an electrical machine, having:
several rotor segments, which are arranged successively along a rotational axis of the rotor and each comprise a rotor plate or several rotor plates,
wherein magnetic poles of two adjacent rotor segments are twisted relative to one another about the rotational axis of the rotor by a staggering angle, and
wherein the staggering angle is smaller than a polar angle lying between two magnetic poles of a rotor segment; and
at least two first cutouts which are arranged on a first hole circle around the rotational axis of the rotor and are each twisted relative to one another by an angle which corresponds to the polar angle minus or plus the staggering angle.

2. The rotor according to claim 1, wherein at least n/2 first cutouts arranged on the first hole circle, of which at least n/2−1 first cutouts are each twisted relative to one another by an angle which corresponds to the polar angle MA minus or plus the staggering angle, wherein n indicates the number of magnetic poles of a rotor segment.

3. The rotor according to claim 1, wherein each two first cutouts lying opposite one another in pairs are arranged on a straight line through the centre of the first hole circle.

4. The rotor according to claim 1, wherein a first of the at least two cutouts is arranged on the first hole circle and is twisted relative to a polar axis of a magnetic pole by half the staggering angle.

5. The rotor according to claim 1, wherein a group of first cutouts is arranged on the first hole circle, wherein an axis of symmetry of the group passing through the rotational axis of the rotor is twisted relative to a polar axis of a magnetic pole by half the staggering angle.

6. The rotor according to claim 1 several second cutouts which are arranged on a second hole circle, and of which at least some are fitted with a balancing weight.

7. The rotor according to claim 6, wherein at least two secondary cutouts are each twisted relative to one another by an angle which corresponds to the polar angle minus or plus the staggering angle, and that the balancing weight extends over at least two rotor segments.

8. The rotor according to claim 1, wherein the magnetic poles of the successively arranged rotor segments
a) starting from one end of the rotor, are each twisted relative to one another in a first direction by a staggering angle progressively, or
b) starting from one end of the rotor up to the middle of the rotor, are each twisted relative to one another in a first direction by a staggering angle progressively, and starting from the middle of the rotor up to the other end of the rotor, are each twisted relative to one another in a second opposite direction by a staggering angle progressively.

9. An electrical machine with a stator, wherein a rotor according to is mounted so as to be rotatable relative to the stator about the rotational axis of the rotor.

10. A vehicle with at least two axles, of which at least one is driven, wherein said drive is provided at least partially or for part of the time by the electrical machine according to claim 9.
